(19) United States
(12) Patent Application Publication
(10) Pub. No.: US 2002/0078182 A1
(43) Pub. Date: Jun. 20, 2002

(54) Failover service method and system

(75) Inventors: Franck Barillaud, Austin, TX (US); Xiaoping Chen, Austin, TX (US); Christopher M. Morrissey, Round Rock, TX (US)

Correspondence Address: Frank C. Nicholas, CARDINAL LAW GROUP, 1603 Orrington Avenue, Suite 2000, Evanston, IL, 60201, US

(73) Assignee: International Business Machines Corporation

(21) Appl. No.: 09/738,370

(22) Filed: Dec. 15, 2000

(51) Int. Cl. G06F 15/177

(52) U.S. Cl. 709/220

(57) ABSTRACT

A failover system of a distributed data processing system is disclosed. The failover system includes a primary service server, a backup service server, a configuration server, and a monitoring server. The primary service server is operable to provides a network service to clients of a distributed data processing system in response to configuration information for supporting the primary service server in providing the network service. The configuration server provides the configuration information to the primary service server in response to a service identification from the primary service server. The monitoring server monitors the provision of the network service by the primary service server in response to the service identification from the primary service server and provides the service identification to the backup service server upon a failure of the primary service server. The backup service server is operable to provides the network service in response to the configuration information. The configuration server provides the configuration information to the backup service server in response to the service identification from the backup service server.

### BACKGROUND OF THE INVENTION

1. Field of the Invention

The present invention generally relates to the field of distributed data processing systems, and more particularly relates to managing a configuration files for supporting a network service in a highly distributed network.

2. Description of the Related Art

Typically, in a network of multiple servers, each server is selected as a primary server for providing one or more network services to clients of the network and as a backup server for one or more of the other servers providing other services. When one of the servers fails to provide an assigned network service, it is imperative that the backup server begins to provide the failed network service to clients in a timely manner. However, while it can be feasible to store modules for providing a particular service within a primary server and one or two backup servers, it is not practical to store configuration information for supporting the modules within the primary server and backup server(s) due to variable nature of configuration information.

It is therefore imperative to expediently provide accurate configuration information supporting the failed network service to the backup server to enable the backup server to begin to provide the failed network service in a timely manner. In a network having a significant amount of network services distributed among many servers, the management of all of the configuration information for supporting the network services can be very complex. The computer industry is therefore continually striving to simplify the management of such configurations files.

### SUMMARY OF THE INVENTION

One form of the present invention is a failover method. First, a service module is cold started to provide a network service in response to configuration information for supporting the service module in providing the network service. Second, an agent provides a service identification to a configuration server in response to the cold start of the service module. Third, the configuration server provides the configuration information to the agent in response to the service identification.

In a second form of the present invention, a failover system comprises a primary service server and a configuration server. The primary service server includes a service module and an agent. The service module is operable to provide a network service in response to configuration information for supporting the service module in providing the network service. The agent is operable to provide a service identification to the configuration server in response to a cold start of the service module. The configuration server provides the configuration information to the agent in response to the service identification.

In a third form of the present invention, a computer program product in a computer readable medium comprises a first means for providing a network service in response to configuration information for supporting network service, and a second means for providing a service identification to a configuration server upon a cold start of the first means whereby the configuration server provides the configuration information to the second means in response to the service identification.

The foregoing forms and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1A is schematic diagram of network of distributed data processing systems in accordance with the present invention;

FIG. 1B is a schematic diagram of a computer architecture of a data processing system as known in the art;

FIG. 2 is diagram of one embodiment of a failover system in accordance with the present invention;

FIG. 3A is a flow chart illustrating one embodiment of a cold start routine in accordance with the present invention;

FIG. 3B is a flow chart illustrating one embodiment of a service monitoring routine in accordance with the present invention;

FIG. 3C is a flow chart illustrating one embodiment of a backup service routine in accordance with the present invention; and

FIG. 3D is a flow chart illustrating one embodiment of a service reboot routine in accordance with the present invention.

### DETAILED DESCRIPTION OF THE PRESENTLY PREFERRED EMBODIMENTS

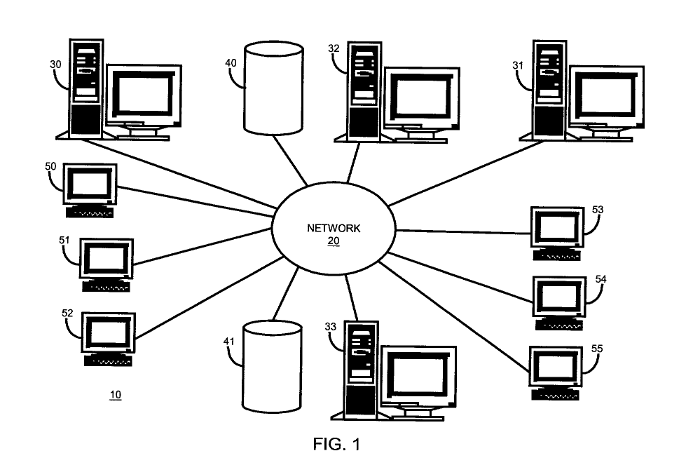

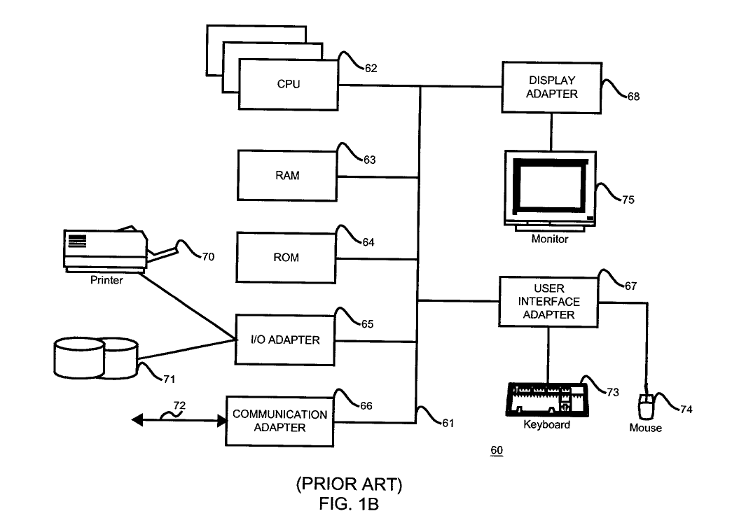

With reference now to the figures, FIG. 1A depicts a network of data processing systems. Distributed data processing system 10 contains network 20, which is the media used to provide communications links between various devices and computers connected together within distributed data processing system 10. Network 20 may include permanent connections, such as wire or fiber optic cables, or temporary connections made through telephone or wireless communications.

In the depicted example, a primary server 31, a backup server 32, a configuration server 33, and a monitoring server 34 in accordance with the present invention are connected to network 20 along with a database 40 and a database 41. In addition, a client 50, a client 51, a client 52, a client 53, a client 54, and a client 55 are connected to network 20. Servers 31-33, and clients 50-55 may be represented by a variety of computing devices, such as mainframes, personal computers, personal digital assistants (PDAs), etc. Distributed data processing system 10 may includes additional servers, clients, networks, routers, and other devices not shown.

Distributed data processing system 10 may include the Internet with network 20 representing a worldwide collection of networks and gateways that use the TCP/IP suite of protocols to communicate with one another. Of course, distributed data processing system 10 may also include a number of different types of networks, such as, for example, an intranet, a local area network (LAN), or a wide area network (WAN).

The present invention could be implemented on a variety of hardware platforms. FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 60 contains one or more central processing units (CPUs) 62 connected to internal system bus 61, which interconnects random access memory (RAM 63, read-only memory (ROM) 64, and input/output adapter 65, which supports various I/O devices, such as printer 70, disk units 71, or other devices not shown, such as a sound system, etc. A communication adapter 66, a user interface adapter 67, and a display adapter 68 are also connected to bus 61. Communication adapter 66 provides bus 61 with access to a communication link 72. User interface adapter 67 connects bus 61 to various user devices, such as keyboard 73 and mouse 74, or other device not shown, such as a touch screen, stylus, etc. Display adapter 68 connects bus 61 to a display device 75.

Those of ordinary skill in the art will appreciate that the hardware in FIG. 1B may vary depending on the system implementation. For example, the system may have one or more processors, and other peripheral devices may be used in addition to or in place of the hardware depicted in FIG. 1B. The depicted example is not meant to imply architectural limitations with respect to the present invention. In addition to being able to be implemented on a variety of hardware platforms, the present invention may be implemented in a variety of software environments. A typical operating system may be used to control program execution within the data processing system.

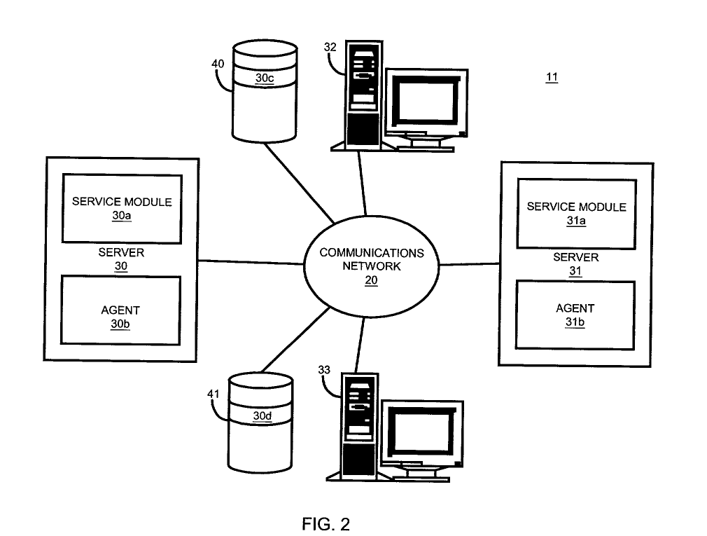

Referring to FIG. 2, a failover system 11 in accordance with the present invention including primary service server 30 (FIG. 1), backup service server 31 (FIG. 1), configuration server 32 (FIG. 1), monitoring server 33 (FIG. 1), database 40 (FIG. 1), and database 41 (FIG. 1) is shown. Primary service server 30 includes a service module 30a and an agent 30b. Service module 30a is operable to provide an assigned network service for distributed data processing system 10, such as, for example, a logging service, an authentication service, a gateway service, etc., in response to configuration information 30c stored within database 40. Configuration information 30c includes information for supporting service module 30a in providing the network service as those of ordinary skill in the art would appreciate, such as, for example, operating limitations for service module 30a and active and inactive features of distributed data processing system 10 involved in allowing communication by clients with service module 30a.

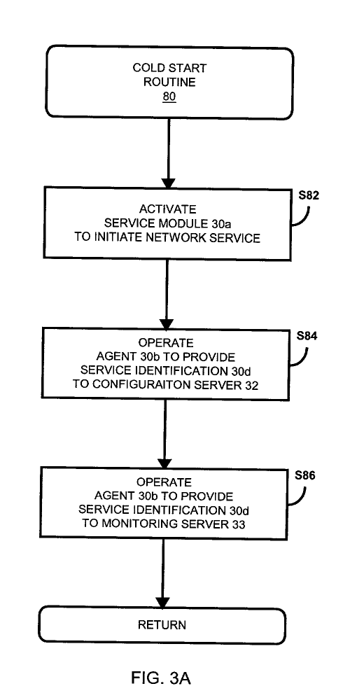

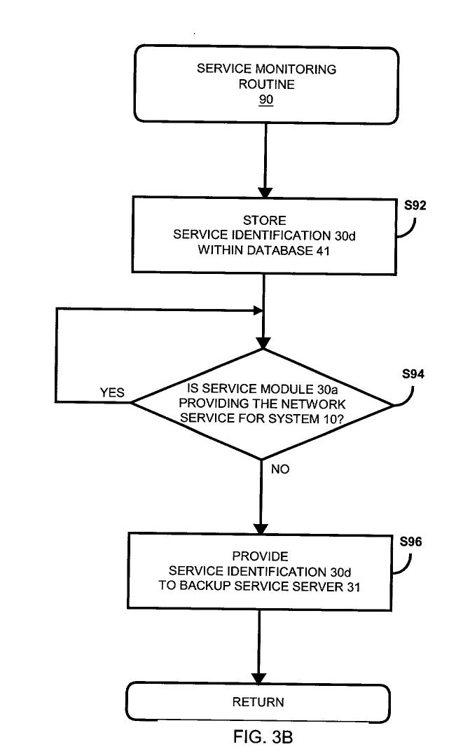

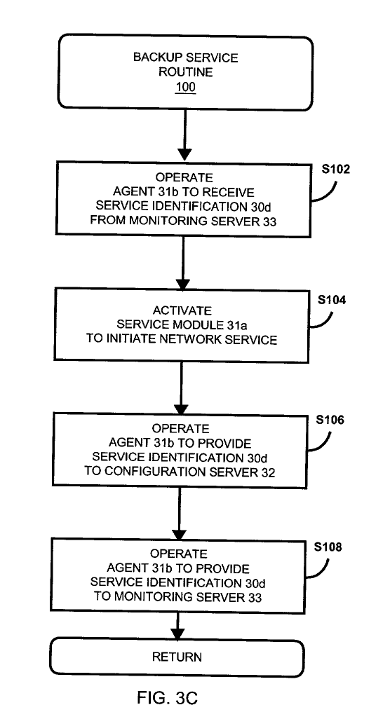

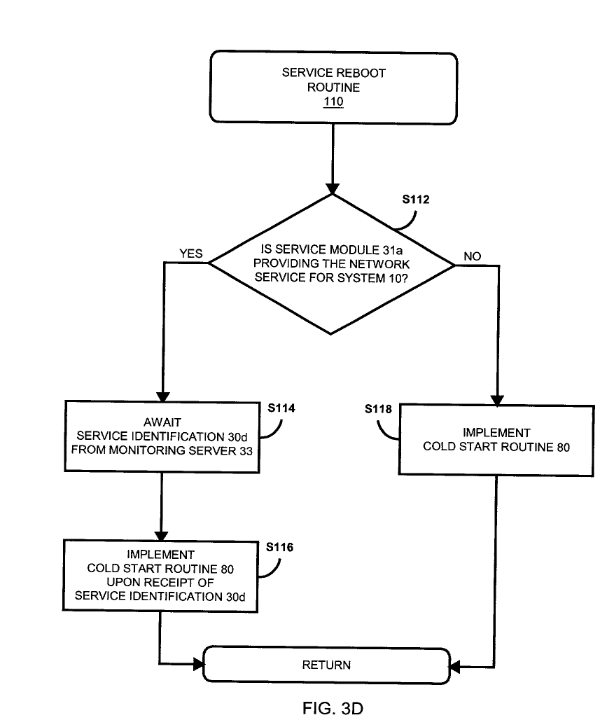

Referring additionally to FIG. 3A, primary service server 30 implements a cold start routine 80 in accordance with the present invention as shown. Service module 30a is activated during a stage S82 of routine 80 to initiate a provision of the network service for distributed data processing system 10 (FIG. 1). Agent 30b is operated during a stage S84 of routine 80 to provide a service identification 30d to configuration server 32. Service identification 30d is an assigned number for indicating to configuration server 32 that service module 30a or a backup service module is in need of configuration information 30b. In response to service identification 30d from agent 30b, configuration server 33 retrieves configuration information 30b from database 40 and provides configuration information 30b to service module 30a. Agent 30b provides service identification 30d to monitoring server 33 during a stage S86 of routine 80. In response to service identification 30d, monitoring server 33 implements a service monitoring routine 90 in accordance with the present invention as shown in FIG. 3B.

Referring to FIGS. 2 and 3B, monitoring server 33 stores service identification 30d within database 41 during a stage S92 of routine 90. Monitoring server 33 determines during a stage S94 of routine 90 if service module 30a is actively providing the network service for distributed data processing system 10 (FIG. 1). In one embodiment, monitoring server 33 attempts to communicate with primary service server 30. A successful communication with primary service server 30 indicates service module 30a is actively providing the network service for distributed data processing system 10. Conversely, an unsuccessful communication with primary service server 30 indicates service module 30a is inactive.

If monitoring server 33 determines during stage S94 of routine 90 that service module 30a is actively providing the network service, then monitoring server 33 will repeat stage S94 after a pre-defined interval, e.g., a two (2) minute interval.

If monitoring server 33 determines during stage S94 of routine 90 that service module 30a is inactive, then monitoring server will proceed to a stage S96 of routine 90 to provide service identification 30d to backup service server 31. In response to service identification 30d, backup service server 31 implements a backup service routine 100 as shown in FIG. 3C.

Referring to FIGS. 2 and 3C, backup service server 31 includes a service module 31a and an agent 31b. Service module 31a is operable to provide the network service for distributed data processing system 10 (FIG. 1) in response to configuration information 30d. Agent 31b is operated during stage S102 of routine 100 to receive service identification 30d from monitoring server 33 and to thereafter activates server module 31a during stage S104 of routine 100 to initiate a provision of the network service for distributed data processing system 10. During stage S106 of routine 100, agent 31b provides service identification 30d to configuration server 40. In response to service identification 30d from agent 31b, configuration server 33 retrieves configuration information 30c from database 40 and provides configuration information 30b to service module 31a. During stage S108 of routine 100, agent 31b provides service identification 30d to monitoring server 33 and in response to service identification 30d from agent 31b, monitoring server 33 implements service monitoring routine 90 (FIG. 3B) for backup service server 31. As such, primary service server 30 can now serve as a backup server to backup service server 31 if active or another server of distributed data processing system 10 (FIG. 1A) can server as a backup server to backup service server 31.

Referring to FIGS. 2 and 3D, primary backup server 30 implements a service reboot routine 110 in accordance with the present invention when serving as a backup to backup service server 31. During stage S112 of routine 110, primary backup server 30 determines if service module 31a is providing the network service for distributed data processing system 10 (FIG. 1A). In one embodiment, agent 30b attempts to communicate with agent 31b. A successful communication with agent 31b indicates service module 31a is actively providing the network service. Conversely, an unsuccessful communication with agent 31b indicates service module 31a is inactive.

If primary backup server 30 determines during stage S112 of routine 100 that service module 31a is actively providing the network service, then primary backup server 30 proceeds to stage S114 of routine 100 to await service identification 30d from monitoring service 33. Primary backup server 30 implements cold start routine 80 (FIG. 3A) in response to service identification 30d from monitoring service 33.

If primary backup server 30 determines during stage S112 of routine 100 that service module 31a is inactive, then primary backup server 30 proceeds to stage S116 of routine 100 to implement cold start routine 80.

Referring to FIGS. 1, 2 and 3A-D, from the preceding description herein of distributed data processing system 10 of failover service system 11, those skilled in the art will appreciate that additional failover systems in accordance with the present invention may be designed and concurrently operated for other services of distributed data processing system 10. In addition, those skilled in the art will appreciate that one or more failover systems in accordance with the present invention may be designed and operated for other networks of distributed data processing systems.

It is important to note that while the present invention has been described in the context of a fully functioning data processing system, those of ordinary skill in the art will appreciate that the processes of the present invention are capable of being distributed in the forms of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, CD-ROM, and transmission-type media, such as digital and analog communications links.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method, comprising:
cold starting a first service module for providing a network service in response to a set of configuration information for supporting said service module in providing said network service;
operating a first agent to provide a service identification to a configuration server upon said cold start; and
operating said configuration server to provide said set of configuration information to said first agent in response to said service identification.

2. The method of claim 1, further comprising:
operating said first service module to provide said network service in response to a receipt of said configuration information by said first agent;
operating said first agent to provide said service identification to a monitoring server upon said cold start; and
operating said monitoring server to monitor a provision of said network service by said first service module in response to said service identification.

3. The method of claim 2, further comprising:
operating said monitoring server to provide said service identification to a second agent upon a failure of said first service module to provide said network service.

4. The method of claim 3, further comprising:
activating a second service module in response to a receipt of said service identification by said second agent, said second service module for providing said network service in response to said set of configuration information;
operating said second agent to provide said service identification to said configuration server;
operating said configuration server to provide said set of configuration information to said second agent in response to said service identification.

5. The method of claim 4, further comprising:
operating said second service module to provide said network service in response to a receipt of said configuration information by said second agent;
operating said second agent to provide said service identification to said monitoring server upon receipt of said set of configuration information; and
operating said monitoring server to monitor a provision of said network service by said second service module.

6. The method of claim 5, further comprising:
operating said monitoring server to provide said service identification to said first agent upon a failure of said second service module to provide said network service.

7. The method of claim 4, further comprising:
operating said second service module to provide said network service in response to a receipt of said configuration information by said second agent;
operating said second agent to provide said service identification to said monitoring server upon receipt of said set of configuration information; and
operating said first agent to monitor said provision of said network service by said second service module when said first service module is operable to resume providing said network service.

8. The method of claim 7, further comprising:
operating said first agent to provide said service identification to said configuration server when said first agent detects a failure of said second service module to provide said network service.

9. A method, comprising:
operating a first service module to provide a network service in response to a set of configuration information;
operating a first agent to provide a service identification to a monitoring server, said service identification corresponding to said configuration information; and
operating said monitoring server to monitor a provision of said network service by said first service module in response to said service identification.

10. The method of claim 9, further comprising:
operating said monitoring server to provide said service identification to a second agent upon a failure of said first service module to provide said network service.

11. The method of claim 9, further comprising:
activating a second service module in response to a receipt of said service identification by said second agent, said second service module for providing said network service in response to said set of configuration information;
operating said second agent to provide said service identification to said configuration server;
operating said configuration server to provide said set of configuration information to said second agent in response to said service identification.

12. The method of claim 11, further comprising:
operating said second service module to provide said network service in response to a receipt of said configuration information by said second agent;
operating said second agent to provide said service identification to said monitoring server upon receipt of said set of configuration information; and
operating said monitoring server to monitor a provision of said network service by said second service module.

13. The method of claim 12, further comprising:
operating said monitoring server to provide said service identification to said first agent upon a failure of said second service module to provide said network service.

14. The method of claim 11, further comprising:
operating said second service module to provide said network service in response to a receipt of said configuration information by said second agent;
operating said second agent to provide said service identification to said monitoring server upon receipt of said set of configuration information; and
operating said first agent to monitor said provision of said network service by said second service module when said first service module is operable to resume providing said network service.

15. The method of claim 14, further comprising:
operating said first agent to provide said service identification to said configuration server when said first agent detects a failure of said second service module to provide said network service.

16. A method, comprising:
operating a first service module to provide a network service in response to a set of configuration information;
operating a monitoring server to monitor a provision of said network service by said first service module; and
operating said monitoring server to provide a service identification to an agent upon a failure of said first service module to provide said network service.

17. The method of claim 16, further comprising:
activating a second service module in response to a receipt of said service identification by said agent, said second service module for providing said network service in response to said set of configuration information;
operating said agent to provide said service identification to a configuration server;
operating said configuration server to provide a set of configuration information to said agent in response to said service identification.

18. The method of claim 17, further comprising:
operating said second service module to provide said network service in response to a receipt of said configuration information by said agent;
operating said agent to provide said service identification to said monitoring server upon receipt of said set of configuration information; and
operating said monitoring server to monitor a provision of said network service by said second service module.

19. A distributed computing system, comprising:
a configuration server operable to provide a set of configuration information in response to a service identification; and
a primary service server including
a first service module operable to provide a network service in response to said set of configuration information for supporting said first service module in providing said network service, and
a first agent operable to provide said service identification to said configuration server upon a cold start of said first service module.

20. The distributed computing system of claim 19, further comprising:
a monitoring server operable to monitor a provision of said network service by said first service module in response to said service identification,
wherein said first agent is further operable to provide said service identification to said monitoring server upon said cold start of said first service module.

21. The distributed computing system of claim 20, further comprising
a backup service server including
a second service module operable to provide said network service in response to said set of configuration information, and
a second agent operable to activate said second service module in response to said service identification.

22. The distributed computing system of claim 21, wherein
said monitoring server is further operable to provide said service identification to said second agent upon a failure of said first service module to provide said network service;
said second agent is further operable to provide said service identification to said configuration server; and
said configuration server is further operable to provide said set of configuration information to said second agent in response to said service identification from said second agent.

23. The distributed computing system of claim 22, wherein:
said second agent is further operable to provide said service identification to said monitoring server upon receipt of said set of configuration information from said configuration server; and
said monitoring server is further operable to monitor a provision of said network service by said second service module in response to said service identification from said second agent.

24. The distributed computing system of claim 23, wherein:
said monitoring server is further operable to provide said service identification to said first agent upon a failure of said second service module to provide said network service.

25. The distributed computing system of claim 22, wherein:
said second agent is further operable to provide said service identification to said monitoring server upon receipt of said set of configuration information from said configuration server; and
said first agent is further operable to monitor said provision of said network service by said second service module when said first service module is operable to resume providing said network service.

26. The distributed computing system of claim 25, wherein:
said first agent is further operable to provide said service identification to said configuration server when said first agent detects a failure of said second service module to provide said network service.

27. A distributed computing system, comprising:
a primary service server including
a first agent, and
a first service module operable to provide a network service in response to a set of configuration information for supporting said first service module in providing said network service; and
a monitoring server operable to monitor a provision of said network service by said first service module in response to a service identification from said first agent,
wherein said first agent is operable to provide said service identification to said monitoring server upon a cold start of said first service module.

28. The distributed computing system of claim 27, further comprising
a backup service server including
a second service module operable to provide said network service in response to said set of configuration information, and
a second agent operable to activate said second service module in response to said service identification.

29. The distributed computing system of claim 28, further comprising:
a configuration server is further operable to provide said set of configuration information to said second agent in response to said service identification from said second agent, wherein
said monitoring server is further operable to provide said service identification to said second agent upon a failure of said first service module to provide said network service, and
said second agent is further operable to provide said service identification to said configuration server.

30. The distributed computing system of claim 29, wherein:
said second agent is further operable to provide said service identification to said monitoring server upon receipt of said set of configuration information from said configuration server; and
said monitoring server is further operable to monitor a provision of said network service by said second service module in response to said service identification from said second agent.

31. The distributed computing system of claim 30, wherein:
said monitoring server is further operable to provide said service identification to said first agent upon a failure of said second service module to provide said network service.

32. The distributed computing system of claim 29, wherein:
said second agent is further operable to provide said service identification to said monitoring server upon receipt of said set of configuration information from said configuration server; and
said first agent is further operable to monitor said provision of said network service by said second service module when said first service module is operable to resume providing said network service.

33. The distributed computing system of claim 32, wherein:
said first agent is further operable to provide said service identification to said configuration server when said first agent detects a failure of said second service module to provide said network service.

34. A distributed computing system, comprising:
a primary service server including a first service module operable to provide a network service in response to a set of configuration information for supporting said first service module in providing said network service;
a monitoring server operable to monitor a provision of said network service by said first service module; and
a backup service server including
a second service module operable to provide said network service in response to said set of configuration information, and
an agent operable to activate said second service module in response to said service identification from said monitoring server.

35. The distributed computing system of claim 34, further comprising:
a configuration server is further operable to provide said set of configuration information to said second agent in response to said service identification from said agent, wherein
said monitoring server is further operable to provide said service identification to said agent upon a failure of said first service module to provide said network service, and
said agent is further operable to provide said service identification to said configuration server.

36. The distributed computing system of claim 35, wherein:
said agent is further operable to provide said service identification to said monitoring server upon receipt of said set of configuration information from said configuration server; and
said monitoring server is further operable to monitor a provision of said network service by said second service module in response to said service identification from said second agent.

37. A computer program product in a computer readable medium, said computer program product comprising:
a first means for providing a network service in response to a set of configuration information, and
a second means for providing a service identification to a configuration server upon a cold start of said first means whereby said configuration server provides said set of configuration information to said second means in response to said service identification.

38. A computer program product in a computer readable medium, said computer program product comprising:
a first means for providing a network service in response to a set of configuration information, and
a second means for monitoring said first means provision of said network service and providing a service identification to a backup service server when said first means fails to provide said network service after receipt of said set of configuration information, said service identification corresponding to said set of configuration information.

39. A computer program product in a computer readable medium, said computer program product comprising:
a first means for providing a network service in response to a set of configuration information when a primary service server fails to provide said network service;
a second means for providing a service identification to a configuration server when said primary service server fails to provide said network service to thereby receive said set of configuration information, said service identification corresponding to said set of configuration information.
